(19) United States
(12) Patent Application Publication
(10) Pub. No.: US 2025/0162724 A1
(43) Pub. Date: May 22, 2025

(54) BATTERY WITH INTEGRATED MAINTENANCE CIRCUIT, ASSOCIATED VEHICLE AND METHOD

(71) Applicant: SAFT, LEVALLOIS PERRET (FR)

(72) Inventor: Jérôme COUMONT, GRADIGNAN (FR)

(73) Assignee: SAFT, LEVALLOIS PERRET (FR)

(21) Appl. No.: 18/839,969

(22) PCT Filed: Feb. 27, 2023
(86) PCT No.: PCT/EP2023/054851

§ 371 Date: Aug. 20, 2024

(30) Foreign Application Priority Data
Feb. 28, 2022 (FR) FR2201720

(51) Int. Cl. B64D 45/00; H01M 10/42; H01M 50/583; H02J 7/00

(52) U.S. Cl. CPC B64D 45/00; H01M 10/425; H01M 50/583; H02J 7/0069; B64D 2045/0085; H01M 2010/4271; H01M 2200/103; H01M 2220/20

(57) ABSTRACT

The present invention relates to a battery comprising a casing, the casing defining an interior space, the battery comprising a set of internal elements, the internal elements being inserted into the interior space, the set of internal elements comprising: at least one electrochemical element, a system for managing the at least one electrochemical element, and a circuit for maintaining the at least one electrochemical element, the maintaining circuit being able to obtain a measurement of a parameter relative to the state of health of the at least one electrochemical element.

### CROSS REFERENCE TO RELATED APPLICATIONS

The present application is a U.S. National Phase Application under 35 U.S.C. § 371 of International Patent Application No. PCT/EP2023/054851 filed Feb. 27, 2023, which claims priority of French Patent Application No. 22 01720 filed Feb. 28, 2022. The entire contents of which are hereby incorporated by reference.

### FIELD OF THE INVENTION

The present invention relates to a battery and an associated method of maintaining the battery.

### BACKGROUND

In the field of aviation, batteries are used for a plurality of applications, in particular at the start-up of engines or to power critical systems in the event of a failure of the main power supply thereof. Thereof implies that an aircraft typically comprises between 1 and 4 batteries per aircraft.

Moreover, for environmental issues, it is envisaged to use hybrid kerosene-electricity engines. Thereof will lead to an increase in battery usage and hence to the presence of additional batteries in the aircraft.

Each of such batteries is subject to maintenance operations to ensure the safe flight of the aircraft, so battery maintenance is an activity that will take more and more time.

There is thus a need for batteries which are easier to maintain, more particularly allowing batteries to be transported in failure mode as per the regulations in force.

### SUMMARY

To this end, the description describes a battery including a casing, the casing defining an interior space, the battery comprising a set of internal elements, the internal elements being inserted into the interior space, the set of internal elements comprising:
at least one electrochemical element,
a system of management of the at least one electrochemical element, and
a maintenance circuit for the at least one electrochemical element, the maintenance circuit being suitable for obtaining a measurement of a parameter relating to the state of health of the at least one electrochemical element.

According to other particular embodiments, the battery has one or a plurality of the following features, taken individually or according to all technically possible combinations:
the management system has at least two states, an operational state and a failure state, the maintenance circuit being suitable for discharging the battery to a state of charge less than or equal to a threshold value when the management system is in the failure state, the threshold value being between 10% and 50%.
the battery comprises an activation device of the maintenance circuit including a dry contact.
the parameter relating to the state of health of the at least one electrochemical element is the internal resistance and/or the capacity.
the battery further comprises a contactor interposed between a pole of the at least one electrochemical element and an output terminal and the maintenance circuit includes a unit for monitoring the current delivered by the at least one electrochemical element, the current control unit being positioned between the contactor and a pole of the at least one electrochemical element.
the current control unit includes a regulation device, the regulation device being e.g. a transistor.
the maintenance circuit further comprises an electrical protection device for the maintenance circuit.
the protection device is a fuse.

The description further proposes a vehicle, in particular an aircraft, including a battery as described hereinabove.

The description further concerns a method of maintenance of a battery including a casing, the casing defining an interior space, the battery comprising a set of internal elements, the internal elements being inserted into the interior space, the set of internal elements comprising:
at least one electrochemical element,
a system of management of the at least one electrochemical element, and
a maintenance circuit for the at least one electrochemical element, the maintenance circuit being suitable for obtaining a measurement of a parameter relating to the state of health of the at least one electrochemical element, the maintenance method comprising:
sending a command to the maintenance circuit to obtain a measurement of a parameter relating to the state of health of the at least one electrochemical element.

In the present description, the expression “suitable for” means equally well “apt to” or “configured for”.

### BRIEF DESCRIPTION OF THE DRAWING

The features and advantages of the invention will appear upon reading the following description, given only as an example, but not limited to, and making reference to the enclosed drawings, wherein:

FIG. 1 is a schematic representation of a vehicle including batteries, and

FIG. 2 is a schematic representation of the elements of battery shown in FIG. 1.

### DETAILED DESCRIPTION

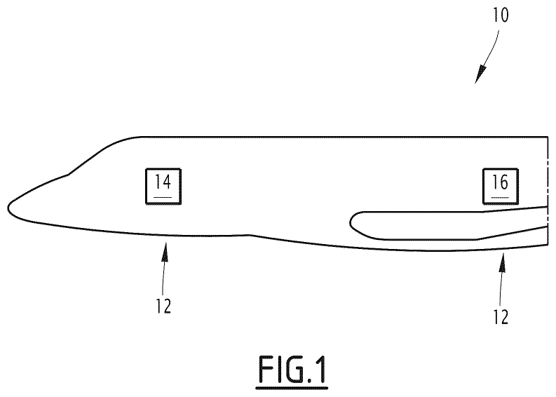

A vehicle 10 is schematically represented in FIG. 1. More precisely, the vehicle 10 is an aircraft 10.

An aircraft is a means of transport which can rise and move at altitude within the Earth's atmosphere.

Herein, the aircraft 10 is an airplane.

In a variant, the aircraft 10 is a helicopter.

Moreover, other types of vehicles could be considered, such as motor vehicles or rail vehicles (trains, subways or tramways).

The aircraft 10 shown in FIG. 1 includes two batteries 12: a first battery 14 used to start the aircraft 10 and a second battery 16 used as an emergency power supply.

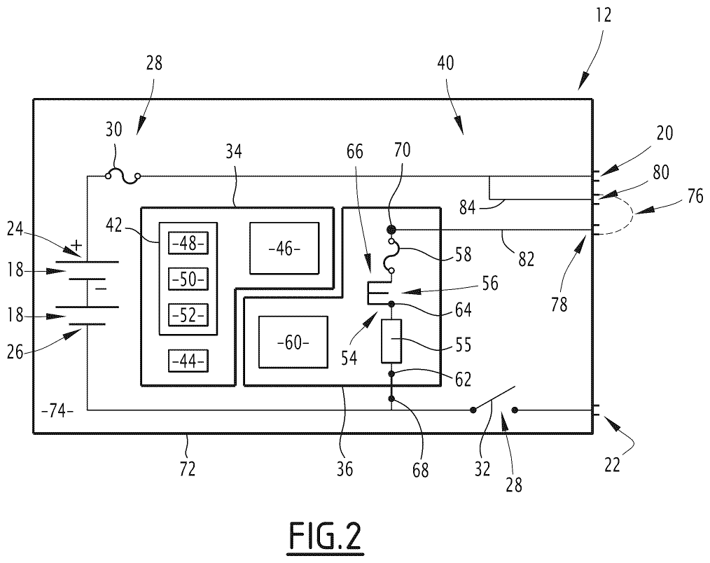

Each of the first and second batteries 14 and 16 are similar and have the different units visible in FIG. 2.

In way known per se, a battery 12 comprises one or a plurality of current accumulators also called electrochemical generators, cells or elements. Such elements will be denoted as electrochemical elements 18 hereinafter in the description.

An electrochemical element 18 is a device for producing electricity wherein chemical energy is converted into electrical energy. The chemical energy comes from electrochemically active compounds deposited on at least one face of electrodes arranged in the electrochemical element 18. Electrical energy is produced by electrochemical reactions during a discharge of the accumulator.

The state of charge of an electrochemical element 18 is often referred to by the abbreviation SOC.

The state of charge (SOC) is expressed as a percentage of a maximum state of charge.

The electrodes are arranged in a container and are electrically connected to current output terminals 20 and 22 (a positive outlet terminal 20 and a negative output terminal 22, respectively) which provide electrical continuity between the electrodes and an electrical consumer with which the electrochemical element 18 is associated.

In order to increase the electrical power delivered, it is possible to combine a plurality of electrochemical elements 18, sealed from one another, to form a battery 12. Thereby, a battery 12 can be divided into modules, each module being composed of one or a plurality of electrochemical elements 18 connected together in series and/or in parallel. Thereby, a battery 12 can e.g. include one or a plurality of parallel branches of accumulators connected in series and/or one or a plurality of parallel branches of modules connected in series.

For simplifying the presentation, a case with two electrochemical elements 18 in series is described hereinafter, knowing that the transposition to other arrangements (a single element or more than two elements) is immediate.

The two electrochemical elements 18 have a positive pole 24 and a negative pole 26.

In the example shown in FIG. 1, the positive pole 24 is connected to the positive output terminal 20 and the negative pole 26 is connected to the negative output terminal 22.

As an example, the electrochemical elements 18 are lithium-ion elements.

Moreover, the battery 12 further includes a unit 28 for securing the battery 12 in the event of a malfunction.

The securing unit 28 isolates the electrochemical elements 18 from the electronic components power-supplied by the battery 12.

According to the example described, the securing unit 28 includes a fuse 30 and a contactor 32.

As an example, fuse 30 is connected to the positive output terminal 20 whereas the contactor 32 is connected to the negative output terminal 22.

Other embodiments of the securing unit 28 are of course possible.

In particular, the securing unit 28 may include two contactors 32 instead of a single contactor, each contactor 32 being connected to a respective output terminal 20 and 22 of the battery 12.

The battery 12 further includes other units for controlling the electrochemical elements 18.

In the present example, the battery 12 includes a management system 34 for the electrochemical elements 18, a maintenance circuit 36 for the electrochemical elements 18 and an activation device 40 for the maintenance circuit 36.

The management system 34 is a system apt to manage the electrochemical element 18.

Such a system 34 can be used in particular for organizing and controlling the charging and discharging of the battery 12, in order to balance the charging and the discharging of the different electrochemical elements 18 of the battery 12 with respect to one another.

In the example described, the management system 34 has at least two states, an operational state and a failure state. In the operational state, as the name thereof indicates, the management system 34 is apt to perform all of the functions thereof whereas, in the failure state, the management system 34 cannot provide at least one of the functions thereof.

In practice, the management system 34 enters the failure state when the management system 34 detects an anomaly with respect to the expected operation of the battery 12. For example, the management system 34 may consider that too high a current or voltage or a faulty contactor are anomalies justifying entering the failure state.

The management system 34 includes a set of measurement sensors 42, a balancing unit 44 and a first electronic control circuit 46.

In this case, the measuring sensor assembly 42 comprises three sensors, namely: a voltage sensor 48 suitable for measuring the voltage across the terminals of the electrochemical elements 18, a current sensor 50 suitable for measuring the current delivered by the electrochemical elements 18 and a temperature sensor 52 suitable for measuring the temperature of the electrochemical elements 18.

The sensors of the set of measurement sensors 42 are placed between the fuse 30 and the contactor 32.

The balancing unit 44 is suitable for balancing the electrochemical elements 18.

For this purpose, the balancing unit 44 includes a set of balancing resistors (not shown) to keep the FIG. 2 clearly legible.

Each balancing resistor is associated with a respective electrochemical element 18 and has an activated and a deactivated state.

In the activated state, the balancing resistor is connected to the electrochemical element 18 to discharge same, whereas in the deactivated state, the balancing resistor is not connected to the electrochemical element 18. Switching from one state to another state is, e.g. achieved by a switching an electronically controlled switch.

To achieve a balancing of the electrochemical elements 18, the balancing resistors corresponding to the electrochemical elements 18 having the highest states of charge are placed in the activated state to homogenize the states of charge of all the electrochemical elements 18.

The first electronic control circuit 46 is suitable for controlling the set of measurement sensors 42 and the balancing unit 44.

The first electronic control circuit 46 is also suitable for controlling the electrochemical elements 18 and the securing unit 28.

Depending on the applications, the first electronic control circuit 46 is also suitable for processing the measurements coming from the sensors.

The first electronic control circuit 46 is an electronic circuit designed for handling and/or transforming data represented as electronic or physical quantities in registers of the calculator and/or memories in other similar data corresponding to physical data in the register memories or other types of displays, transmission devices or storage devices.

As specific examples, the first electronic control circuit 46 comprises a single-core or multi-core processor (such as a central processing unit (CPU), a graphics processing unit (GPU), a microcontroller and a digital signal processor (DSP), a programmable logic circuit (such as an application specific integrated circuit (ASIC), an array of field programmable gates (FPGAs), a programmable logic device (PLD) and programmable logic arrays (PLAs), a state machine, a logic gate, and discrete hardware components.

The maintenance circuit 36 is suitable for obtaining a measurement of a parameter relating to the state of health of the electrochemical elements 18.

The state of health is often referred to by the abbreviation SOH. The state of health (SOH) is used for estimating the aging of the battery 12 between a new state and an end-of-life state, or more generally, between an initial state and a final state.

A parameter relating to the state of health is any parameter involved in the state of health, such as, e.g. values of the temperature, the voltage or the current of the electrochemical elements 18.

Other examples will be given hereinafter in the description.

The maintenance circuit 36 include a current control unit 54, a protection device 58 and a second electronic control circuit 60.

The current control unit 54 is a unit for controlling the current delivered by the electrochemical elements 18.

The current control unit 54 in combination with the second electronic control circuit 60 and the measurement of current serves to regulate and control the discharge current.

The current control unit 54 is interposed between the contactor 32 and the electrochemical elements 18.

More precisely, the current control unit 54 comprises a resistor 55 and a current regulation device 56.

The resistor 55 has two terminals 62 and 64, one terminal 62 being connected both to the contactor 32 and to the negative pole 26 of the electrochemical elements 18 and the other terminal 64 being connected indirectly to the positive pole 24 of the electrochemical elements 18.

The regulation device 56 is connected both to a terminal 64 of the resistor 55 and to the protection device 58.

The resistor 55 and the regulation device 56 are thereby in series.

The regulation device 56 acts both as a current regulator and as a switch.

As a switch, the regulation device 56 has an open state and a closed state.

The regulation device 56 is e.g. a transistor, in particular an insulated gate field-effect transistor. Such a transistor is most often called a MOSFET, the acronym for Metal Oxide Semiconductor Field-Effect Transistor.

In such a case, the regulation device 56 performs the role of regulator by operating in the linear mode thereof.

To improve regulation, the regulation device 56 may include more than one transistor, e.g. two transistors in series.

The protection device 58 is a device for electrical protection of the elements of the maintenance circuit 36.

According to the example described, the protection device 58 is a fuse.

Furthermore, in FIG. 2, the protection device 58 is in series with the current control unit 54.

The assembly of the protection device 58 and of the current control unit 54 thereby forms a branch 66 in parallel with the electrochemical elements 18. The branch 66 extends between two ends 68 and 70, the first end 68 of the branch 66 being connected to the negative pole 26 of the electrochemical elements 18 and to the contactor 32.

The second electronic control circuit 60 is suitable for implementing a set of functions. The functions are maintenance functions and correspond to steps of a method for maintaining the battery 12.

Some of the functions will be described more precisely hereinafter in the description.

From a physical point of view, the second electronic control circuit 60 can be made in the same way as the first electronic control circuit 46.

In certain advantageous embodiments, the first electronic control circuit 46 and the second electronic control circuit 60 are merged, i.e. the electronic control circuits are implemented as a single calculator.

In such a case, the elements of the calculator involved in performing the maintenance functions belong to a separate partition from the element or elements of the computer performing the functions of the first electronic control circuit 46, so that the maintenance functions are isolated from the functions of the first electronic control circuit 46.

The activation device 40 of the maintenance circuit 36 is suitable for activating or deactivating the maintenance circuit 36.

The activation device 40 thereby enables an operator to control the second electronic control circuit 60 from the outside.

The outside is defined with respect to the casing 72 which includes the battery 12.

The casing 72 delimits indeed an interior space 74.

The electrochemical elements 18, the management system 34 of the electrochemical elements 18, the maintenance circuit 36 of the electrochemical elements 18 and the contactor 32 are elements inserted into the interior space 74. As such, same are internal elements of the battery 12.

The management system 34 and the maintenance circuit 36 are thereby each an on-board circuit integrated into the battery 12.

The casing 72 is provided with the positive output terminal 20 and the negative output terminal 22.

The activation device 40 includes a dry contact 76 including ends 78 and 80 and connections 82 and 84 connected to a respective end 78 or 80 of the dry contact 76.

A dry contact 76 is an electrical contact with no potential difference between the two terminals thereof, unlike e.g. a resistor.

The dry contact 76 can thus be activated by an operator by connecting a terminal to the dry contact 76.

By activating the dry contact 76, the maintenance circuit 36 is activated whereas when the dry contact 76 is not activated, the maintenance circuit 36 is deactivated.

The ends 78 and 80 are on the case 72 of the battery 12.

The first connection 82 connects the first end 78 of the dry contact 76 to the second end 70 of the branch 66.

As explained hereinabove, in use, the maintenance circuit 36 shown in FIG. 2 can perform a plurality of functions which are now described.

An operator can perform a maintenance operation using the maintenance circuit 36.

It is assumed herein that maintenance is carried out while the aircraft 10 is on the ground.

The operator connects a terminal to the dry contact 76 on a connection terminal present on the casing 72, the terminal and the maintenance circuit 36 thereby being connected by a wire connection.

In a variant, the terminal and the maintenance circuit 36 can communicate by wireless communication.

The terminal is e.g. a tablet serving as a human-machine interface.

The terminal thereby allows the operator to control the maintenance circuit 36 and in particular the functions thereof.

As an example, the operator asks the maintenance circuit 36 to perform a first function corresponding to performing a discharge function of the electrochemical elements 18.

The maintenance circuit 36 is indeed, herein, suitable for discharging the electrochemical elements 18 up to a state of charge threshold, even if the management system 34 is in the failure state.

The state of charge threshold is less than or equal to a threshold value.

The threshold value is between 10% and 50%, preferably between 20% and 30%, or even equal to 30%.

According to a first embodiment, the maintenance circuit 36 controls the balancing unit 44 to activate all the balancing resistors and thereby discharge the electrochemical elements 18.

The maintenance circuit 36 stops the activation of the balancing resistors as soon as the state of charge is less than or equal to the desired state of charge threshold.

According to a second embodiment, the second electronic control circuit 60 controls the state of the regulation device 56. The second electronic control circuit 60 activates the regulation device 56 to discharge the electrochemical elements 18 and opens same when the electrochemical elements 18 have a state of charge less than or equal to the desired state of charge threshold.

In the present example of embodiment, the maintenance circuit 36 is suitable for determining the value of the state of charge on the basis of the measurements of the set of measurement sensors 42.

As an example of a second function, the maintenance circuit 36 serves to measure the capacity of the electrochemical elements 18.

For this purpose, the maintenance circuit 36 ensures that the electrochemical elements 18 are balanced and charged to a selected state of charge.

The maintenance circuit 36 places the contactor 32 in an open state.

Furthermore, the temperature sensor 52 measures the temperature at said full state of charge.

The second electronic control circuit 60 then controls the regulation device 56 to let the desired current flow.

The electrochemical elements 18 are then discharged to the minimum voltage thereof.

During the discharge, the current sensor 50 measures the value of the current delivered by the electrochemical elements 18.

By activating a time counter, the second electronic control circuit 60 deduces from the current values measured over time, a measurement of the capacity.

The second electronic control circuit 60 then compares the capacity thereby measured with a reference capacity value.

The reference capacity value is obtained using the measured temperature.

Such comparison serves to determine the presence of a discrepancy between the capacity of the battery 12 and the expected capacity of the latter.

The result of the comparison is displayed on the operator terminal and stored in a memory of the battery 12 forming part of one of the electronic control circuits.

For example, a simple message such as “normal behavior” or “malfunction” is sent.

Alternatively, the second electronic control circuit 60 determines the state of health SOH from the ratio between the capacity of the battery 12 at a given time and the capacity of the battery in the new or initial state under the same measurement conditions (in particular under the same temperature conditions).

In fact, capacity decreases with aging, reflecting a loss of available energy. In such a case, the expression “State of Health related to battery Capacity” or the abbreviation SOHC thereof, relating to the capacity of the battery 12, is often used.

In such a case, the SOHC parameter is displayed on the terminal and stored in the aforementioned memory.

As an example of a third function, the maintenance circuit 36 serves to measure the internal resistance of the electrochemical elements 18.

Similarly to the case of the second function, the maintenance circuit 36 imposes a full discharge on the electrochemical elements 18.

During the discharge, the current sensor 50 measures the value of the current delivered by the electrochemical elements 18 and the voltage sensor 48 measures the value of the voltage across the terminals of the electrochemical elements 18.

The second electronic control circuit 60 deduces from the measured values the value of the internal resistance of the electrochemical elements 18, the latter being the ratio between the voltage and the current.

The second electronic control circuit 60 then compares the internal resistance thereby measured with a reference internal resistance value

The internal resistance value is obtained using the measured temperature.

The comparison is used to determine whether the internal resistance corresponds to the internal resistance.

The result of the comparison is displayed on the operator terminal and stored in a memory of the battery 12 forming part of one of the electronic control circuits.

For example, a simple message such as “normal behavior” or “malfunction” is sent.

Alternatively, the second electronic control circuit 60 determines the state of health SOH by calculating the ratio between the internal resistance thereby measured by the measurement of the voltage and of the current on the internal resistance of the battery 12 in the new or initial state under the same measurement conditions (in particular under the same temperature conditions).

In fact, the internal resistance increases with the aging of the battery 12, reflecting a loss of power. In such a case, the expression “State of Health related to battery Resistance” or the abbreviation SOHR thereof, relating to the internal resistance of the battery 12, is often used.

In such a case, the SOHR parameter is displayed on the terminal and stored in the aforementioned memory.

Of course, many other functions can be envisaged and the abovementioned functions can be combined.

For example, it could be considered to implement both the second function and the third function and to display a SOH parameter dependent on the SOHC and SOHC parameters.

The maintenance circuit 36 thereby serves to carry out maintenance operations integrated into the battery 12. As a result, there is no need to use an additional device to ensure the maintenance and repair operations and thereby maintenance becomes easier.

The maintenance circuit 36 thereby serves to ensure the maintenance on the ground of aircraft 10 without external equipment.

More particularly, the maintenance circuit 36 serves to perform checks on the correct operation of the battery 12, by measuring the capacity or the internal resistance of the battery 12.

More particularly, the maintenance circuit 36 can be used to discharge the battery 12 even if the battery 12 is in a failure state.

Furthermore, the maintenance circuit 36 can be activated by the operator via the activation device 40 and controlled by the terminal.

In this way, the maintenance circuit 36 can be activated only on the ground during the maintenance phase. The operator can activate such function via a human-machine interface.

1. A battery including a casing, the casing defining an interior space, the battery comprising a set of internal elements, the internal elements being inserted into the interior space, the set of internal elements comprising:
at least one electrochemical element,
a management system of said at least one electrochemical element, and
a maintenance circuit for the at least one electrochemical element, the maintenance circuit obtaining a measurement of a parameter relating to the state of health of the at least one electrochemical element.

2. The battery according to claim 1, wherein the management system has at least two states, an operational state and a failure state, the maintenance circuit being suitable to discharge the battery to a state of charge less than or equal to a threshold value when the management system is in the failure state, the threshold value being between 10% and 50%.

3. The battery according to claim 1, wherein the battery comprises an activation device for the maintenance circuit having a dry contact.

4. The battery according to claim 1, wherein the parameter relating to the state of health of the at least one electrochemical element is the internal resistance and/or the capacity.

5. The battery according to claim 1, wherein the battery further comprises a contactor interposed between a pole of the at least one electrochemical element and an output terminal the maintenance circuit comprising a current control unit delivered by the at least one electrochemical element, the current control unit being positioned between the contactor and a pole of the at least one electrochemical element.

6. The battery according to claim 5, wherein the current control unit comprises a regulation device.

7. The battery according to claim 1, wherein the maintenance circuit further comprises an electrical protection device for the maintenance circuit.

8. The battery according to claim 7, wherein the protection device is a fuse.

9. A vehicle, in particular an aircraft comprising a battery according to claim 1.

10. A method of maintaining a battery comprising a casing, the casing defining an interior space, the battery comprising a set of internal elements, the internal elements being inserted into the interior space, the set of internal elements comprising:
at least one electrochemical element,
a management system of said at least one electrochemical element, and
a maintenance circuit for the at least one electrochemical element, the maintenance circuit for obtaining a measurement of a parameter relating to the state of health of the at least one electrochemical element, the maintenance method comprising:
sending a command to the maintenance circuit to obtain a measurement of a parameter relating to the state of health of the at least one electrochemical element.

11. The battery according to claim 6, wherein the regulation device is a transistor.
